(19) United States
(12) Patent Application Publication
(10) Pub. No.: US 2020/0258173 A1
(43) Pub. Date: Aug. 13, 2020

(54) Zip Credit real estate business method

(71) Applicants: Kolin Blain Porter, Tempe, AZ (US); Adam McCurry Carlson, Tempe, AZ (US); Tim Gilker, Queen Creek, AZ (US)

(72) Inventors: Kolin Blain Porter, Tempe, AZ (US); Adam McCurry Carlson, Tempe, AZ (US); Tim Gilker, Queen Creek, AZ (US)

(21) Appl. No.: 16/873,142

(22) Filed: Feb. 12, 2020

Related U.S. Application Data
(60) Provisional application No. 62/918,697, filed on Feb. 11, 2019.

(51) Int. Cl. G06Q 50/16; G06Q 50/00; G06Q 40/02; G06Q 30/02

(52) U.S. Cl. CPC G06Q 50/16; G06Q 50/01; G06Q 30/0203; G06Q 30/0214; G06Q 40/025

(57) ABSTRACT

A ZipCredit real estate business method to obtain a real estate loan to a buyer of real estate, the business method comprising a computer medium based program, web based, on line, interface with the computer program is through an on line question and answer process; after the question and answer process the prospect is qualified for a real estate loan, documents are then created through the ZipCredit method computer program, the documents can be uploaded or downloaded providing information of the buyer to a loan officer who quotes an interest rate, amount, and term for a loan through the ZipCredit computer program.

### CROSS-REFERENCE TO RELATED APPLICATIONS

Incorporated by reference is Provisional patent 62/918,697 titled ZipCredit system and method, applicant Kolin Blain Porter, et al, filing date Feb. 11, 2019.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Incorporated by reference is an original and duplicate copy CD comprising programs Makefile.PL, 1 KB, ziperedit.conf, 1 KB, and ziperedit.psgi, 1 KB.

### STATEMENT REGARDING PRIOR DISCLOSURES BY THE INVENTOR OR A JOINT INVENTOR

“Not Applicable”

### BACKGROUND OF THE INVENTION

### (1) Field of the Invention

The field of this invention is in real estate property transactions, computer based, via Social Media Referrals to a real estate prospect who completes an Intake Survey and is presented a Loan Field wherein a consumer can view various loan availabilities for a real estate loan on a property. A mortgage company transaction is expedited through an embodiment of the present ZipCredit real estate business method.

The field of this invention is also in automating, reviewing, executing, and transmitting documents used in a real estate application transaction with a financial lending institution or mortgage transactions by providing document data visualization on a mobile device or desktop allowing for review and execution of all real estate application documents, including promissory notes, deeds of trust, and financial documents on a mobile device such as a computer tablet and relaying these documents to a financial institution or mortgage company via means of the internet or dedicated communications media.

The field of this invention is also in visual display of financial lending data to provide understanding of the data and allowing for electronic execution of financial or escrow documents and allowing for electronic transmission of documents from a financial institution or mortgage company for electronic document filing in a digital media thereby eliminating paper handling and filing, thereby conserving natural resources.

### (2) Description of Related Art Including Information Disclosed Under 37 CFR 1.97

Mortgage company lending transactions, in general, are document intensive. A large portion of these documents are in the loan application and verification of an applicant's creditworthiness for a real estate loan. Loan officers will process the information and consolidate various credit and employment documents. These procedures take time and extend the application process a considerable amount of time before the consumer is considered acceptable for a real estate loan.

It would be advantageous to have a convenient real estate loan application method for a consumer to fulfill the application process in a convenient and expedited method, once having been accepted for a real estate loan through a method that will allow for Mortgage companies to bid for the consumer with competing rates for a real estate loan.

I would further be advantageous to have a paperless device to facilitate document review, and document execution which replicated the process of signing paper documents. Through an electronic medium these documents would be transmitted by a financial institution or mortgage company to a computer or mobile tablet for document review and execution. Executed documents would then be transmitted back to the financial institution or mortgage company.

It would further be advantageous to have a ZipCredit real estate business method adaptable to paperless documents in real estate transactions. Transmission medium would be via the internet or a dedicated communications medium.

### BRIEF SUMMARY OF THE INVENTION

The ZipCredit real estate business method is a computer based method which comprises a consumer obtaining a Social Media Referral, further completing an Intake Survey, selecting a real estate loan from a Loan Field, the business method further determining if the real estate loan is with the Federal Housing Association, if it is then the consumer is directed to a Peoples Mortgage (a standard mortgage company), the consumer pays a Lead Fee and continues on to a ZipCredit Real Estate mortgage company to obtain a loan approval on a real estate property.

In a further embodiment of the ZipCredit real estate business method comprises a consumer obtaining a Social Media Referral, further completing an Intake Survey, selecting a real estate loan from a Loan Field, the business method determining if a real estate loan is with the Federal Housing Association, if it is then the consumer is directed to ZipCredit Real Estate, a mortgage company, to obtain a real estate loan approval which leads to a Consumer Review and further to a payment to consumer.

In still a further embodiment of the ZipCredit real estate business method where a consumer deals directly with ZipCredit Real Estate and signs with a Virtual Agent and views property with the listing agent only and pays the listing agent a fee. If the consumer does not view the property with the listing agent but depends on a ZipCredit Real Estate agent to show the property, the consumer can decide on the property or decline the property and continue viewing other properties.

Essentially the ZipCredit application will be able to either assist or replace the loan officer engagement in a pre-qualification process. ZipCredit will be able to ensure the required information is collected and all questions are correctly asked in the right order.

The present invention, ZipCredit real estate business method further comprises automating, reviewing, executing, and transmitting documents used in real estate mortgage transactions by providing document data visualization on a mobile device allowing for review and execution of financial closing documents, such as promissory notes, deeds of trust and financial documents on a mobile device such as a tablet and relaying these documents to and from the originating financial or mortgage institution, via means of the internet or dedicated communications media.

The present invention ZipCredit real estate business method provides visual display of document data for understanding of this data and allowing for electronic execution of financial closing documents and allowing for electronic transmission of such documents from a financial or mortgage institution in conjunction with a loan applicant for electronic document filing in a digital media, thereby eliminating paper handling and filing, conserving natural resources.

### BRIEF DESCRIPTION OF THE SEVERAL VIEWS OF THE DRAWINGS

FIG. 1 is a flowchart of the ZipCredit real estate business method comprising a consumer obtaining a Social Media Referral 50, further obtaining an Intake Survey 52, determining if a real estate loan is with the Federal Housing Association 54, if it is then the consumer is directed to Peoples Mortgage 56 and pay a Lead Fee 58 and continue to ZipCredit Real Estate 60 and obtain a loan Approval 62.

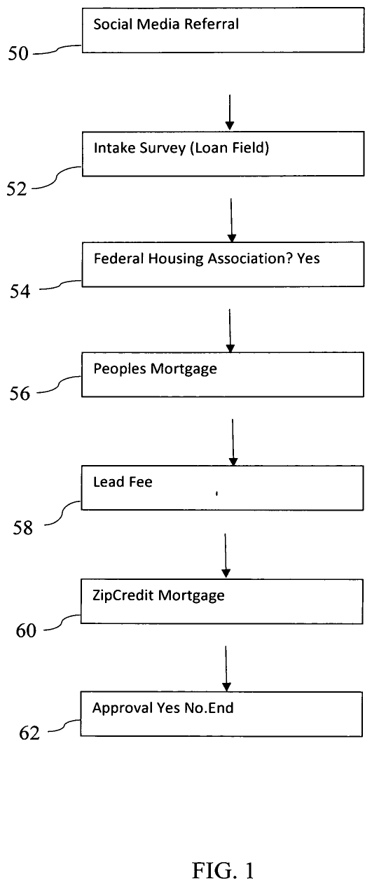

FIG. 2 is a flowchart of the ZipCredit real estate business method comprising a consumer obtaining a Social Media Referral 70, further obtaining an Intake Survey 72, determining if a real estate loan is with the Federal Housing Association 76, if it is then the consumer is directed to ZipCredit Real Estate and obtain a real estate loan approval 78 which leads to a Consumer Review 80 and further to a payment 82 to consumer.

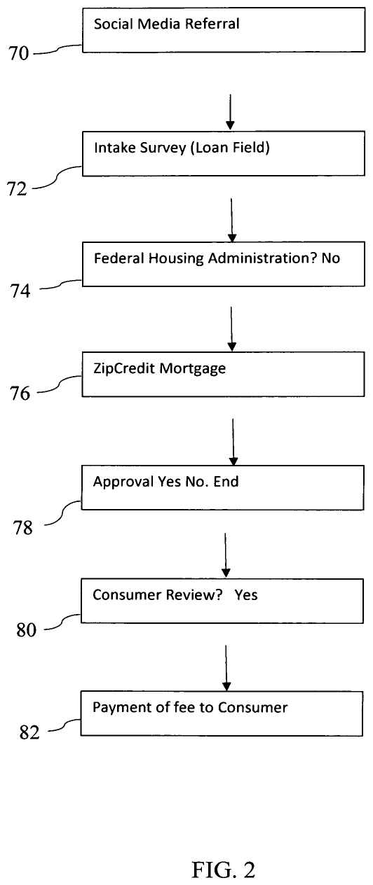

FIG. 3 are steps of the ZipCredit real estate business method when a consumer deals directly with ZipCredit Real Estate 200 and signs with a Virtual Agent 210 and views property with the listing agent only 220 and pays the listing agent a fee. If the consumer does not view the property with the listing agent but depends on a ZipCredit Real Estate Agent 240 to show the house, the consumer can decide on the property 250 or decline the property and continue viewing 260 other properties.

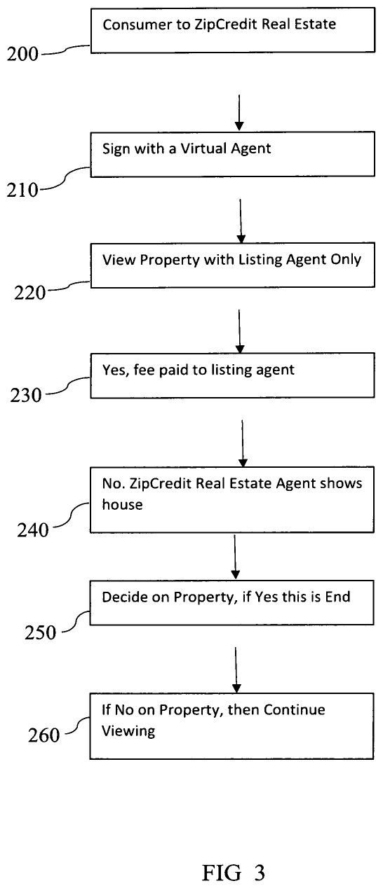

### DETAILED DESCRIPTION OF THE INVENTION

Incorporated by reference is Provisional patent 62/918,697 titled ZipCredit system and method, applicant Kolin Blain Porter, et al, filing date Feb. 11, 2019.

The ZipCredit real estate business method is a computer based method which comprises a consumer obtaining a Social Media Referral, further completing an Intake Survey, selecting a real estate loan from a Loan Field, the business method further determining if the real estate loan is with the Federal Housing Association, if it is then the consumer is directed to a Peoples Mortgage (a standard mortgage company), the consumer pays a Lead Fee and continues on to a ZipCredit Real Estate mortgage company to obtain a loan approval on a real estate property.

In a further embodiment of the ZipCredit real estate business method comprises a consumer obtaining a Social Media Referral, further completing an Intake Survey, selecting a real estate loan from a Loan Field, the business method determining if a real estate loan is with the Federal Housing Association, if it is then the consumer is directed to ZipCredit Real Estate, a mortgage company, to obtain a real estate loan approval which leads to a Consumer Review and further to a payment to consumer.

In still a further embodiment of the ZipCredit real estate business method where a consumer deals directly with ZipCredit Real Estate and signs with a Virtual Agent and views property with the listing agent only and pays the listing agent a fee. If the consumer does not view the property with the listing agent but depends on a ZipCredit Real Estate agent to show the property, the consumer can decide on the property or decline the property and continue viewing other properties.

Essentially the ZipCredit application will be able to either assist or replace the loan officer engagement in a pre-qualification process. ZipCredit will be able to ensure the required information is collected and all questions are correctly asked in the right order.

The present invention, ZipCredit real estate business method further comprises automating, reviewing, executing, and transmitting documents used in real estate mortgage transactions by providing document data visualization on a mobile device allowing for review and execution of financial closing documents, such as promissory notes, deeds of trust and financial documents on a mobile device such as a tablet and relaying these documents to and from the originating financial or mortgage institution, via means of the internet or dedicated communications media.

The present invention ZipCredit real estate business method provides visual display of document data for understanding of this data and allowing for electronic execution of financial closing documents and allowing for electronic transmission of such documents from a financial or mortgage institution in conjunction with a loan applicant for electronic document filing in a digital media, thereby eliminating paper handling and filing, conserving natural resources.

The ZipCredit real estate business method comprises the following steps:
i. obtaining a Social Media Referral;
ii. completing an Intake Survey;
iii. determining if a real estate loan is with the Federal Housing Association;
iv. directing the consumer to Peoples Mortgage;
v. paying a Lead Fee;
vi. continuing to ZipCredit Real Estate; and
vii. obtaining a loan Approval.

The ZipCredit real estate business method in a further embodiment comprises the following steps:
i. obtaining a Social Media Referral;
ii. completing an Intake Survey;
iii. determining if a real estate loan is with the Federal Housing Association;
iv. directing the consumer to ZipCredit Real Estate;
v. obtaining a real estate loan approval;
vi. obtaining a Consumer Review; and
vii. providing a payment to consumer.

A further embodiment of the ZipCredit real estate business method comprises the following steps:
i. dealing directly with ZipCredit Real Estate;
ii. signing with a virtual agent;
iii. viewing a property with the listing agent only;
iv. paying the listing agent a fee;
v. viewing a property with a ZipCredit Real Estate agent instead of a listing agent;
vi. deciding to purchase the property; and
vii. continuing to view other properties if the previous property is not bought.
   The following are descriptions of the various terms used in this disclosure:

### Social Media Referral

Once the lending process is complete, the consumer (borrower) will be presented with an option to give an unbiased review of ZipCredit and post it on their social media account(s). ZipCredit will pay the consumer (borrower) a fee for these unbiased reviews after they have been posted to the agreed upon social media channels. These reviews are posted on a social media platform.

People's Mortgage (Any standard mortgage company)

People's Mortgage is a standard full service mortgage company that has the ability to service all types of loans from traditional to FHA and other government subsidized loans.

### ZipCredit Real Estate

ZipCredit Real Estate will only service traditional mortgages and not FHA and other government subsidized loans. ZipCredit Real Estate is a full service Real Estate company that has virtual agents and offers a fee to listing agents to show properties.

The present invention, ZipCredit real estate business method comprises automating, reviewing, executing, and transmitting documents used in Real Estate transactions by providing document data visualization on a mobile device or desktop allowing for review and execution of financial closing documents, such as promissory notes, deed of trusts, and financial documents on a computer or mobile device such as a tablet and relaying these documents to and from a financial institution via means of the internet or dedicated communications media.

ZipCredit real estate business method provides electronic documents for real estate transactions based on MISMO™ standards, which is the standards development body for the mortgage industry. MISMO™ developed a common language for exchanging information for the mortgage finance industry. MISMO™ standards are accepted and deployed by every type of entity involved in creating mortgages, and they are required by most regulators, housing agencies, and lender's that participate in the industry.

An embodiment of the present invention provides visual display of real estate data for understanding of this data and allowing for electronic execution of financial or escrow documents and allowing for electronic transmission of real estate documents from a borrower to a Mortgage or Title Company for electronic document filing in a digital media, thereby eliminating paper handling and filing, conserving natural resources.

The ZipCredit real estate business method is developed as a mobile application and web based application.

The ZipCredit method provides the following features:
i. Loan Field Mortgage Product;
ii. Global approval process;
iii. Applicants to ZipCredit are sold as leads to other mortgage companies;
iv. Upon loan approval, becomes a universal loan approval;
v. ZipCredit provides a survey, a lead form, to obtain all information from consumer;
vi. Checks credit, sends back approval;
vii. ZipCredit collects all data before a mortgage company gets prospect;
viii. ZipCredit method communicates with a desktop originated underwriter; and
ix. If approved, the ZipCredit method matches prospect with best rate.

Other features of the ZipCredit real estate business method are obtaining offers from a Mortgage company on completion of the process. This disrupts the current mortgage process and removes the Loan Officer technology from the process.

The ZipCredit real estate business method guides an individual through a qualification process with a decision tree logic that is presented further in this disclosure. ZipCredit, comprises a web mobile computer medium to interface with the ZipCredit real estate business method.

The ZipCredit real estate business method is a computer medium based program, web based, online, interface is with the computer program through questions and answers. After the process, the documents created through the ZipCredit method can be uploaded or downloaded providing customer service and support where an individual can speak with a loan agent. Through the ZipCredit method a loan officer quotes a rate for a loan through the software which is user based.

Further advantages of the ZipCredit method is:
i. 24/7 ZipCredit customer service.
ii. What normally takes a traditional loan officer 4 days to accomplish is reduced to 60 minutes through the ZipCredit method.
iii. With the ZipCredit method there are savings to the consumer and reduced cost for a loan application.
iv. The ZipCredit method provides a more inexpensive business method and software.
v. Advantages for a Mortgage Company is to replace officers, with the ZipCredit method providing 24/7 assistance.
vi. Once a mortgage is completed through the ZipCredit method a fee is paid to a consumer for an unbiased review.
vii. The ZipCredit business method is adaptable for use with non-subsidized loans where a fee is paid to provide a consumer to other mortgage companies.
viii. The ZipCredit method generates leads for consumer referrals to competing mortgage companies.
ix. If a prospect is FHA oriented then sell the individual referral to another company that can handle subsidized loans.

The ZipCredit real estate business method further comprises the following steps to establish a ZipCredit Real Estate company:
i. Buying an existing mortgage company;
ii. Eliminating resources not needed within the existing mortgage company;
iii. Replacing the existing mortgage company's existing business method with the ZipCredit real estate method web based survey technology;
iv. Collecting consumer personal information through the ZipCredit method;
v. Providing a question and answer questionnaire to a consumer to collect all personal information; and
vii. Sending out globally the approved mortgage loan provided by the ZipCredit method for competing offers from mortgage companies.

The following is a high level overview of the ZipCredit real estate business method features in the field of real estate documents:
i. A scope of the ZipCredit real estate business method is to facilitate the signing, notarizing and secure transfer of documents to and from financial institutions and their agents.
ii. Improve the financial closing process into a digital format that adheres to MISMO compliance and can securely send and receive financial documents between stakeholders in the workflow process.
   The ZipCredit real estate business method provides for the following features:
i. PDF Document Editing
ii. PDF Document Signing
   The ZipCredit real estate business method contains a fast native mobile canvas to allow digital signatures and digital placement of notary stamps while reviewing or editing the document for signing and stamping.

Workflow Features of the ZipCredit real estate business method help the goal of ZipCredit to improve the process of financial-loan document workflows by allowing digital signatures and notarization, or other document affirmation, of MISMO compliant documents using computer tablets. Customers sign documents that re-create the physical paper signing experience and adheres to the same MISMO compliance.

Applicant Decision Tree

A consumer will encounter the following decision tree once in the ZipCredit method through a web based computer readable medium:

ZipCredit, the most reliable home lender in America. We're excited to help you obtain a ZipApproval™
This application assumes you are in the market to purchase a residential home.

### Start:

1. How many people will be applying for this loan?<drop down>
Open fields for full name, address(s) for the past two years, SS #, DOB, consent to access credit for each applicant
   Note: DOB/SS # can be optional

2. Are any person(s) a US Citizen or Permanent Resident Alien? Y/N
Y: NEXT
N: Unfortunately, we are only able to provide a ZipApproval™ for US Citizens or persons having permanent resident alien status.

3. Is any person married but not including their spouse on this loan application?
Y: Radio button available next to each name above to click for those that apply
Note: Flag file for assets and in community property states for closing

4. What state is the home located in?<drop down>

5. Will you reside in the home most of the time? Y/N
N: Will at least one person shown above reside in the home? Y/N
   N=Investment Property (include definition: Investment home is often called a “rental home”, but the definition doesn't involve collecting rent, instead, it's an investment property if the person or persons that owe the mortgage do not reside in the home.

6. Estimated purchase price?<drop down>

7. Mortgage amount needed?<drop down>
If >97%, then: Are you an honorably discharged veteran?
   N: The maximum loan amount available is (#6×97%) base on the purchase price you entered. Are you able to make a down payment of (#6×3%) from your own savings or money gifted from family?
      Add note (“Quick Tips”) about selling items for down payment and other sources
      N: Non-Occupant CB Section

8. Is any of the down payment borrowed?
Y: Is the loan secured by collateral owned by one of the persons shown above?
   Y: Does the collateral have a title that is registered with a government agency, such as a car, home, or retirement account?
      Y: Enter the expected monthly payment amount of the loan
      N: Borrowed funds are acceptable provided the loan is secured by collateral owned by at least one of the applicants of this loan and the collateral has a title, deed, or registration that is recorded with a government agency, such as a car, home, retirement account, and some recreational vehicles.
N: NEXT

9. Select the closest total amount of funds that meet the criteria below <drop down>
Criteria: Funds that at least one of the persons above have maintained in a checking, savings, retirement, money market, or certificate of deposit for at least 60 days. Please do not include financial investments such as stocks, mutual funds, precious metals, etc.)

10. Will you be using income from a company you own to repay this loan?
Y: Do you own at 25% or more of the business?
   N: NEXT
   Y: How long have you owned more than 25% of the business?<drop down>
   >2 years: NEXT
   <1 year: Have you worked in the same field/occupation for >5 years? Y/N
      N: Non-Occupant CB Section
      Y: NEXT

11. What is the business type: <drop down> Sole/Partnership/LLC/PLLC/Corporation
< > Sole: Have you filed your personal taxes and business taxes for the most recent two years?
   N: Non-Occupant CB (Quick Tip: You can reapply once filed)
   Y: NEXT
=Sole: Have you filed your personal taxes for the most recent two years?
   N: Non-Occupant CB (Quick Tip: You can reapply once filed)
   Y: Did you include your business income on your taxes? Y/N
      N: Non-Occupant CB
      Y: NEXT

12. Have you filed your personal taxes for the most recent two years? Y/N
Y: Do you still owe any taxes for this year's Federal Income Tax filing (1040) Y/N?
   Y: Please enter the amount <field>
      Program note: Subtract from assets/#7<or> estimate payment in DTI
   N: NEXT
N: Is the majority of your income tax exempt? Y/N
   N: W2 Only Program—NEXT
   Y: LOE—NEXT

13. Are you employed? Y/N
Y: Please enter your current employer name(s), check the income type (W2, 1099, cash), and select the length of employment time for each. Please indicate any ownership you may have in the employer <drop downs><25% or more=Self Employment Section>
N: Do you have a stable source of income? Y/N
   Y: Is your income derived from a retirement plan Y/N?
   N: Non-Occupant CB
      Y: Is the retirement income from Social Security Y/N?
         Y: Source (below)
         N: Is the retirement income from a municipal, state, or federal retirement plan
         Y/N?
         Y: Source (below)
         N: Is the income from a defined company pension that will continue at a fixed amount for at least the next 3 years Y/N?
         Y: Source (below)
         N: Non-Occupant CB
      N: Have you received this income for the most recent 6 months? Y/N
         Y: Source (below)
         N: Non-Occupant CB (Quick Tip: You can reapply once it has been received for 6 months)
            Source: Please select the source of your income <drop down> and select the length of time received for each.

14. Are you required to pay any of the obligations below (check all that apply)?
Federal Income Taxes, Alimony, Child Support, Separate Maintenance, Union Dues, Liens, Judgements (have “monthly amount” field next to each item along with a box for “Check if you are not current on this obligation” and “Number of Monthly Payments Remaining”)

15. Please enter the information for any loans you have excluding loans being repaid to a retirement account (401K, etc).
1. <drop down> type: Home Loan, Auto Loan, Credit Card, Student Loan, Other Personal Obligation
2. Field: Balance
3. Field: Monthly Payment

16. Have you filed for bankruptcy in the last 7 years Y/N?
N: NEXT
Y: <Radio Button for Chapter 7/13>; Has the bankruptcy case closed? Y/N
   Y: What month/year was it discharged (discharged was when it ended)<drop down>
   N: If Radio Button=Chapter 7>Decline
      Radio Button=Chapter 13> are you current on all monthly payments to the trustee? Y/N
         Y: How many payments have you made already?
         <drop down>
         N: Ineligible

17. Have you ever had a home loan that you stopped making payments and subsequently forfeited ownership (i.e. foreclosure, short-sale, or deed-in-lieu of foreclosure)? Y/N
Y: —Select the Situation: <drop down> (include definitions: foreclosure, short-sale, or deed-in-lieu of foreclosure)
   —Enter the month/year of the situation <drop down>
   If dropdown=yes AND date is <3 years: decline (unless veteran #7); ELSE Execute Program
N: Execute Program

### NON-OCCUPANT CO-BORROWER Requirements (Default Before Decline)

### Applicable

### Question Above:

(1) ZipApproval™ requires at least 3% contributed from your own savings or gifted from a family member. You can have another person share in qualifying for the loan, who would also share in responsibility for the loan, if they meet same qualifying criteria. That person may contribute all of the down payment using the same rules. Do you know someone that would help? Y/N
(2) ZipApproval™ requires evidence of filing for the most recent two years Federal, personal income taxes (1040 and all related schedules) by business owner. You can have another person share in qualifying for the loan, who would also share in responsibility for the loan, if they meet same qualifying criteria. Do you know someone that would help? Y/N
(3) ZipApproval™ requires that you have stable source of income for consistent repayment each month. You can have another person share in qualifying for the loan, who would also share in responsibility for the loan, if they meet same qualifying criteria. Do you know someone that would help? Y/N
(4) ZipApproval™ requires that your retirement income will continue for at least three years at fixed, monthly amount after you become the owner. You can have another person share in qualifying for the loan, who would also share in responsibility for the loan, if they meet same qualifying criteria. Do you know someone that would help? Y/N
   Y: Non-Occ-CB Questions
   N: We are unable to issue a ZipApproval™ at this time. Please visit www.I-D-10-T.com/Error

Non-Occ-CB to Complete (very similar to above)

1. Please enter full name, address(s) for the past two years, SS #, DOB, consent to access credit for each applicant

Y: Note: DOB/SS # can be optional

### 2. Are you a US Citizen or Permanent Resident Alien? Y/N

Y: NEXT
N: Unfortunately, we are only able to provide a ZipApproval™ for US Citizens or persons having permanent resident alien status.
   2. Is the person married but not including their spouse on this loan application?

Y: Flag file for assets and in community property states for closing

3. Are you able to make a down payment of (#6×3%) from your own savings?
Y: NEXT
N: Unfortunately, we are not able to provide a ZipApproval™ for your particular circumstance. Please reapply once you are able make the (#6×3%) from your savings. Return to the original application? Y/N
   4. Is any of the down payment borrowed? Y/N
N: NEXT
Y: Is the loan secured by collateral owned by you? Y/N
   N: Unfortunately, we are not able to provide a ZipApproval™ for your particular circumstance. Please reapply once you are able make the (#6×3%) from your savings. Return to the original application?
   Y: Does the collateral have a title that is registered with a government agency, such as a car, home, or retirement account?
      Y: Enter the expected monthly payment amount of the loan
      N: Unfortunately, we are not able to provide a ZipApproval™ for your particular circumstance. Please reapply when you have access to borrowed funds for the (#6×3%) down payment which is secured by collateral having a title that is registered with a government agency, such as a car, home, or retirement account.
         5. Select the closest total amount of funds that meet the criteria below <drop down>
Criteria: Funds that have maintained in a checking, savings, retirement, money market, or certificate of deposit for at least 60 days. Please do not include financial investments such as stocks, mutual funds, precious metals, etc.)
   6. Will you be using income from a company you own to repay this loan? Y/N
Y: Do you own at least 25% of the business?
   Y: How long have you owned more than 25% of the business?<drop down>
      2 years: NEXT
      <2 years: Unfortunately, we are not able to provide a ZipApproval™ for your particular circumstance. Please reapply once you have been self-employed for two years. Return to the original application? Y/N
N: NEXT
   7. What is the business type: <drop down> Sole/Partnership/LLC/PLLC/Corporation
< > Sole: Have you filed your personal taxes and business taxes for the most recent two years?
   N: Non-Occupant CB (Quick Tip: You can reapply once filed)
   Y: NEXT
=Sole: Have you filed your personal taxes for the most recent two years?
   N: Unfortunately, we are not able to provide a ZipApproval™ for your particular circumstance. Please reapply when you have filed your personal, federal income taxes. Return to the original application?
   Y: Did you include your business income on your taxes? Y/N
      N: Unfortunately, we are not able to provide a ZipApproval™ for your particular circumstance. Please reapply when you have filed your personal, federal income taxes. Return to the original application?
      Y: NEXT
         8. Have you filed your personal taxes for the most recent two years? Y/N
Y: Do you still owe any taxes for this year's Federal Income Tax filing (1040) Y/N?
   Y: Please enter the amount <field>
      Program note: Subtract from assets/#7<or> estimate payment in DTI
   N: is the majority of your income tax exempt? Y/N
      N: W2 Only; NEXT
         9. Are you employed? Y/N
Y: Please enter your current employer name(s), check the income type (W2, 1099, cash), and select the length of employment time for each. Please indicate any ownership you may have in the employer <drop downs><25% or more=Self Employment Section>
N: Do you have a stable source of income? Y/N
   Y: Is your income derived from a retirement plan Y/N?
   N: Unfortunately, we are not able to provide a ZipApproval™ for your particular circumstance. Please reapply when you have a stable source of income. Return to the original application? Y/N
      Y: Is the retirement income from Social Security Y/N?
         Y: Source (Below)
         N: Is the retirement income from a municipal, state, or federal retirement plan
         Y/N?
         Y: Source (Below)
         N: Is the income from a defined company pension that will continue at a fixed amount for at least the next 3 years Y/N?
         Y: Source (Below)
         N: Unfortunately, we are not able to provide a ZipApproval™ for your particular circumstance. Please reapply when you have fixed income that will continue for three years after taking ownership of the home. Return to the original application? Y/N
      N: Have you received this income for the most recent 6 months? Y/N
         Y: Source (Below)
         N: Unfortunately, we are not able to provide a ZipApproval™ for your particular circumstance. Please reapply after you have received the income for at least six months.
            Source: Please select the source of your income <drop down> and select the length of time received for each.
            10. Are you required to pay any of the obligations below (check all that apply)?
Federal Income Taxes, Alimony, Child Support, Separate Maintenance, Union Dues, Liens, Judgements (have “monthly amount” field next to each item along with a box for “Check if you are not current on this obligation” and “Number of Monthly Payments Remaining”)
   11. Please enter the information for any loans you have excluding loans being repaid to a retirement account (401K, etc).
a. <drop down> type: Home Loan, Auto Loan, Credit Card, Student Loan, Other Personal Obligation
b. Field: Balance
c. Field: Monthly Payment
   12. Have you filed for bankruptcy in the last 7 years Y/N:
N: NEXT
Y: <Radio Button for Chapter 7/13>; Has the bankruptcy case closed? Y/N
   Y: What month/year was it discharged (discharged was when it ended)<drop down>
   N: If Radio Button=Chapter 7>Decline
      Radio Button=Chapter 13>are you current on all monthly payments to the trustee? Y/N
      Y: How many payments have you made already? <drop down>
      N: Unfortunately, we are not able to provide a ZipApproval™ for your particular circumstance. Please reapply once your Ch. 13 bankruptcy has closed. Return to the original application?
         13. Have you ever had a home loan that you stopped making payments and subsequently forfeited ownership (i.e. foreclosure, short-sale, or deed-in-lieu of foreclosure)? Y/N
Y: —Select the Situation: <drop down> (include definitions: foreclosure, short-sale, or deed-in-lieu of foreclosure)
   —Enter the month/year of the situation <drop down>
   If dropdown=yes AND date is <3 years: decline (unless veteran #7); ELSE Execute Program
N: Execute Program

The ZipCredit method executes its program through a computer readable medium to provide results leading to an approved or disapproved real estate loan. An approved real estate loan is now in condition for competing bids from various mortgage companies through this method.

What is claimed is:

1. A ZipCredit real estate business method, the method is computer based, to obtain a real estate loan for a consumer comprising the following steps by the consumer:
obtaining a Social Media Referral;
completing an Intake Survey;
determining if a real estate loan is with the Federal Housing Association;
directing the consumer to Peoples Mortgage;
paying a Lead Fee;
continuing on to ZipCredit Real Estate; and
obtaining a loan Approval.

2. The real estate business method of claim 1 wherein obtaining a Social Media Referral comprises the consumer receiving referrals from others via social media internet communication.

3. The real estate business method of claim 1 wherein completing an Intake Survey comprises answering an accumulation of questions leading to qualifying a consumer for a real estate loan.

4. The real estate business method of claim 1 wherein determining if a real estate loan is with the Federal Housing Administration comprises inquiry of the financial propriety of the present real estate loan by the business method.

5. The real estate business method of claim 1 wherein directing the consumer to People's Mortgage, which is any standard mortgage company, comprises direct communication with the consumer to interact with People's Mortgage.

6. The real estate business method of claim 1 wherein paying a Lead Fee comprises obtaining a payment from the consumer to provide leads to real estate properties and financing options through People's Mortgage.

7. The real estate business method of claim 1 wherein continuing on to ZipCredit Real Estate comprises selecting a financing option for a real estate property through ZipCredit Real Estate.

8. A real estate financing method to obtain financing for a real estate buyer comprising the following steps:
obtaining a Social Media Referral;
obtaining an Intake Survey;
determining if a real estate loan is with the Federal Housing Association;
directing the buyer to ZipCredit Real Estate;
obtaining a real estate loan approval;
leading to a Consumer Review; and
providing a payment to the buyer.

9. The real estate financing method of claim 8 wherein obtaining a Social Media Referral comprises the buyer receiving referrals from others via social media internet communication.

10. The real estate financing method of claim 8 wherein obtaining an Intake Survey comprises the buyer to engage in a question and answer computer based process to accumulate information on the real estate buyer and prequalify the buyer for the real estate loan.

11. The real estate financing method of claim 8 wherein determining if a real estate loan is with the Federal Housing Administration comprises inquiry of the financial propriety of a real estate loan.

12. The real estate financing method of claim 8 wherein directing the real estate buyer to ZipCredit Real Estate comprises direct communication with the buyer to interact with ZipCredit Real Estate.

13. The real estate financing method of claim 8 wherein obtaining a real estate loan comprises the buyer negotiating a real estate loan directly with ZipCredit Real Estate.

14. The real estate financing method of claim 8 wherein leading to a Consumer Survey comprises the buyer providing feedback on the financing of the real estate loan through ZipCredit Real Estate.

15. The real estate financing method of claim 8 wherein providing payment to the real estate buyer comprises purchasing of the real estate property and recording of real estate documents.

16. The real estate financing method of claim 8 wherein to provide financing for the buyer of real estate comprises the following steps by the buyer:
dealing directly with ZipCredit Real Estate;
signing with a ZipCredit Real Estate Virtual Agent;
viewing a property with a listing agent only;
paying the listing agent a fee;
viewing the property with a ZipCredit Real Estate agent;
deciding to purchase the property; and
continuing to view other properties if the previous property is not bought.

17. The real estate financing method of claim 16 wherein signing with a ZipCredit Real Estate Virtual Agent comprises the buyer signing a computerized document to request the real estate loan and submitting the document to the virtual agent by computer.

18. A ZipCredit real estate business method to obtain a real estate loan to a customer, the business method comprising a computer medium based program, web based, on line, interface with the computer program is through an on line question and answer process; after the question and answer process and the customer is qualified for a real estate loan, documents are then created through the ZipCredit business method computer program, the documents can be uploaded or downloaded providing information of the customer to a loan officer who quotes an interest rate, amount, and term for a loan through the ZipCredit computer program.

19. The ZipCredit real estate business method of claim 18 further comprises qualifying the customer for a real estate loan through a qualification process by presenting computer based questions to the customer, answers to the questions result in qualification or disqualification of the customer for a real estate loan, the business method further comprising presentation of competing real estate loans from lenders for selection by the customer, loan quotes by lenders include amount of loan, term, and financing interest rate.
